(19) United States
(12) Patent Application Publication
(10) Pub. No.: US 2026/0023163 A1
(43) Pub. Date: Jan. 22, 2026

(54) MANAGING DETECTION EFFICIENCY ASSOCIATED WITH OPTICAL PHASED ARRAY PATTERN LOBES USING ASYMMETRIC ELEMENT FACTORS

(71) Applicant: Analog Photonics LLC, Boston, MA (US)

(72) Inventors: Benjamin Roy Moss, Cambridge, MA (US); Michael Robert Watts, Hingham, MA (US)

(73) Assignee: Analog Photonics LLC, Boston, MA (US)

(21) Appl. No.: 19/271,077

(22) Filed: Jul. 16, 2025

Related U.S. Application Data
(60) Provisional application No. 63/673,010, filed on Jul. 18, 2024.

(51) Int. Cl. G01S 7/481

(52) U.S. Cl. CPC G01S 7/4815

(57) ABSTRACT

An apparatus comprises: at least one transmit aperture configured to provide an optical beam having a far-field angular intensity pattern comprising first and second lobes at first and second angular positions; and a plurality of receive apertures configured to receive optical beams, each receive aperture comprising a respective optical phased array (OPA) formed by a plurality of antenna elements, where each antenna element comprises: a waveguide coupled to a phase shifter, and a plurality of grating elements arranged along the waveguide according to an element factor; wherein the element factors associated with at least two different OPAs of respective receive apertures correspond to different respective far-field angular intensity patterns that at least partially overlap; wherein the far-field angular intensity pattern of the at least one transmit aperture at least partially overlaps with the far-field angular intensity patterns of the at least two different OPAs of respective receive apertures.

### CROSS-REFERENCE TO RELATED APPLICATION(S)

This application claims the benefit of and priority to U.S. Provisional Application Ser. No. 63/673,010, entitled “MANAGING DETECTION EFFICIENTCY ASSOCIATED WITH OPTICAL PHASED ARRAY PATTERN LOBES USING ASYMMETRIC ELEMENT FACTORS,” filed Jul. 18, 2024, which is incorporated herein by reference.

### STATEMENT AS TO FEDERALLY SPONSORED RESEARCH

This invention was made with government support under the following contracts: Army Research Lab via the National Center for Manufacturing Sciences Collaboration Agreement 2023196-142386; and Office of Naval Research N00014-23-C-1046. The government has certain rights in the invention.

### TECHNICAL FIELD

This disclosure relates to managing detection efficiency associated with optical phased array pattern lobes using asymmetric element factors.

### BACKGROUND

Some optical systems, i.e., light detection and ranging (LiDAR) systems or optical communication systems, can be configured to transmit optical waves and/or receive optical waves. Some systems can optimize various aspects of a configuration based on different criteria. In some optical communication systems, optical waves can be transmitted from optical sources and collected by receivers. Some optical communication systems can be configured as free space optical communication systems wherein optical waves propagate through air or space between a transmitter or receiver. In some LiDAR systems, an optical wave is transmitted from an optical source to target object(s) at a given distance and the light reflected from the target object(s) is collected.

In some examples, a system can transmit or receive light using optical phased arrays (OPAs). Some optical phased arrays (OPAs) used in such systems have a linear distribution of emitter elements (also called emitters or antennas). Steering about a first axis perpendicular to the linear distribution can be provided by changing the relative phase shifts in phase shifters feeding each of the emitter elements. Other techniques can be used for steering about a second axis orthogonal to the first axis. The optical source used in such a system is typically a laser, which provides an optical wave that has as narrow linewidth and has a peak wavelength that falls in a particular range (e.g., between about 100 nm to about 1 mm, or some subrange thereof), also referred to herein as simply “light.”

### SUMMARY

In one aspect, in general, an apparatus comprises: at least one transmit aperture configured to provide an optical beam having a far-field angular intensity pattern comprising a first lobe at a first angular position and a second lobe at a second angular position different from the first angular position; and a plurality of receive apertures configured to receive optical beams, each receive aperture of the plurality of receive apertures comprising a respective optical phased array (OPA) formed by a plurality of antenna elements, where each antenna element of the plurality of antenna elements comprises: a waveguide coupled to a phase shifter, and a plurality of grating elements arranged along the waveguide according to an element factor associated with the respective OPA; wherein the element factors associated with at least two different OPAs of respective receive apertures of the plurality of receive apertures correspond to different respective far-field angular intensity patterns that at least partially overlap; wherein the far-field angular intensity pattern of the at least one transmit aperture at least partially overlaps with the far-field angular intensity patterns of the at least two different OPAs of respective receive apertures of the plurality of receive apertures.

Aspects can include one or more of the following features.

The apparatus further comprises a signal processing module configured to process optical signals received from the plurality of receive apertures to resolve a detected event associated with either the first lobe or the second lobe of the far-field angular intensity pattern of the at least one transmit aperture.

The signal processing module is further configured to resolve a detected event associated with both of the first lobe and the second lobe of the far-field angular intensity pattern of the at least one transmit aperture.

An element factor associated with an OPA of a first receive aperture corresponds to an asymmetric far-field angular intensity pattern.

An element factor associated with an OPA of a second receive aperture corresponds to an asymmetric far-field angular intensity pattern that is different from the asymmetric far-field angular intensity pattern of the first receive aperture.

An element factor associated with an OPA of a second receive aperture corresponds to a symmetric far-field angular intensity pattern.

The at least one transmit aperture comprises an OPA with a plurality of antenna elements, each antenna element of the plurality of antenna elements comprising a respective plurality of waveguides coupled to respective phase shifters, and a plurality of grating elements arranged along each waveguide of the respective plurality of waveguides according to a respective element factor associated with the OPA of the at least one transmit aperture.

The element factor of the OPA of the at least one transmit aperture is different from the element factors associated with the at least two different OPAs of the plurality of receive apertures.

The element factor of the OPA of the at least one transmit aperture corresponds to a symmetric far-field angular intensity pattern that at least partially overlaps with the far-field angular intensity patterns of the at least two different OPAs of the receive aperture.

Each grating element of the plurality of grating elements of each antenna element of the plurality of antenna elements of an OPA of at least one receive aperture of the plurality of receive apertures comprises a first portion positioned to perturb a first portion of a wavefront of an optical wave at a first location along a propagation axis of a waveguide, and a second portion positioned to perturb a second portion of the wavefront at a second location along the propagation axis different from the first location, where the second portion of the wavefront is at least partially non-overlapping with the first portion of the wavefront.

That grating element of the plurality of grating elements comprises: the first portion in contact with the waveguide at the first location and extending along a direction substantially perpendicular to the propagation axis, and the second portion in contact with the waveguide at the second location and extending along a direction substantially perpendicular to the propagation axis.

The first portion and the second portion of a particular grating element are connected to each other.

Each antenna element of a plurality of antenna elements of an OPA of at least one receive aperture of the plurality of receive apertures comprises the plurality of grating elements distributed along the waveguide along a propagation axis of the waveguide, the plurality of grating elements comprising: a first set of grating elements with adjacent grating elements separated from each other along the propagation axis by a first length, and a second set of grating elements with adjacent grating elements separated from each other along the propagation axis by the first length, where the second set of grating elements is separated from the first set of grating elements along the propagation axis by a gap without any grating elements at least twice as large as the first length.

Each element factor associated with an OPA of a receive aperture of the plurality of receive apertures corresponds to a different respective far-field angular intensity pattern, where the far-field angular intensity patterns of any two OPAs of respective receive apertures of the plurality of receive apertures at least partially overlap.

The first lobe corresponds to a main lobe of the far-field angular intensity pattern of the at least one transmit aperture and the second lobe corresponds to a side lobe of the far-field angular intensity pattern of the at least one transmit aperture.

In another aspect, in general, a method comprises: transmitting, using a transmit aperture, an optical beam having a far-field angular intensity pattern comprising a first lobe at a first angular position and a second lobe at a second angular position different from the first angular position; receiving, at each receive aperture of at least two receive apertures, respective optical beams, where each receive aperture of the at least two receive apertures comprises a respective optical phased array (OPA) that is configured according to different respective far-field angular intensity patterns; comparing one or more detected events associated with an optical beam received at a first receive aperture of the at least two receive apertures with one or more detected events associated with an optical beam received at a second receive aperture of the at least two receive apertures; and determining, based at least in part on a result of the comparing, whether the optical beam received at the first receive aperture corresponds to the first lobe or the second lobe of the optical beam transmitted by the transmit aperture; wherein the far-field angular intensity patterns of the at least two receive apertures at least partially overlap.

Aspects can include one or more of the following features.

Each OPA of each receive aperture of the at least two receive apertures comprises a respective plurality of waveguides, each waveguide of the respective plurality of waveguides coupled to a respective phase shifter, and a plurality of grating elements arranged along each waveguide of the respective plurality of waveguides according to an element factor associated with that OPA.

Each element factor of a respective OPA of a respective receive aperture of the at least two receive apertures corresponds to the different respective far-field angular intensity pattern of the respective OPA.

Each element factor corresponds to a different respective asymmetric far-field angular intensity pattern.

The first lobe is a main lobe of the far-field angular intensity pattern of the transmit aperture and the second lobe is a side lobe of the far-field angular intensity pattern of the transmit aperture.

Each of the optical beam received at the first receive aperture and the optical beam received at the second receive aperture comprise respective back-reflected portions of the optical beam transmitted by the transmit aperture associated with at least one of the first lobe or the second lobe.

The method further comprises comparing one or more respective detected events associated with a respective optical beam arriving at each receive aperture of the at least two receive apertures with respective detected events associated with a respective optical beam arriving at each other receive aperture of the at least two receive apertures.

The comparing one or more detected events associated with an optical beam received at a first receive aperture of the at least two receive apertures with one or more detected events associated with an optical beam received at a second receive aperture of the at least two receive apertures further comprises comparing a first probability distribution that is determined based at least in part on the one or more detected events associated with an optical beam received at the first receive aperture of the at least two receive apertures and a second probability distribution that is determined based at least in part on the one or more detected events associated with an optical beam received at the second receive aperture of the at least two receive apertures.

The comparing one or more detected events associated with an optical beam received at a first receive aperture of the at least two receive apertures with one or more detected events associated with an optical beam received at a second receive aperture of the at least two receive apertures further comprises determining at least one of: a range of an object interacting with the first lobe, a range of an object interacting with the second lobe, a speed of an object interacting with the first lobe, or a speed of an object interacting with the second lobe.

In another aspect, in general, a method of configuring a LiDAR system comprises: configuring at least one transmit aperture to provide an optical beam having a far-field angular intensity pattern comprising a first lobe at a first angular position and a second lobe at a second angular position different from the first angular position; and arranging a plurality of receive apertures relative to the transmit aperture, each receive aperture of the plurality of receive apertures comprising a respective optical phased array (OPA) formed by a plurality of antenna elements, where each antenna element of the plurality of antenna elements comprises: a waveguide coupled to a phase shifter, and a plurality of grating elements arranged along the waveguide according to an element factor associated with the respective OPA; wherein the element factors associated with at least two different OPAs of respective receive apertures of the plurality of receive apertures correspond to different respective far-field angular intensity patterns that at least partially overlap; wherein the far-field angular intensity pattern of the at least one transmit aperture at least partially overlaps with the far-field angular intensity patterns of the at least two different OPAs of respective receive apertures of the plurality of receive apertures.

Aspects can have one or more of the following advantages.

In some examples, one or more receive apertures of a LiDAR system can be configured such that the apertures are more sensitive to certain regions of the FOV in a LiDAR scene. This angular sensitivity can allow determination of the region from which light is received, thus allowing delineation of a first lobe and a second lobe, i.e., a main lobe and a side lobe, in a phased-array LiDAR system. Using the methods and techniques disclosed herein, a LiDAR system can be associated with increased light collection efficiency, parallelism and usable field-of-view (FOV).

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. The plots resulting from numerical simulations, as indicated below, are working examples of experimental results associated with some of the techniques described herein, and other plots are prophetic examples of expected experimental results.

FIGS. 1A-1E are schematic diagrams of example optical systems.

FIGS. 1F-1G are plots of numerical simulations associated with configuring optical systems.

FIG. 2 is a schematic diagram of an example of a LiDAR system.

FIG. 3A is a schematic diagram of an example of an optical phased array.

FIG. 3B is a schematic diagram of an example of an optical switched array.

FIG. 3C is a schematic diagram of an example of an optical switched array system.

FIG. 4 is a schematic diagram of an example of a grating-antenna-based optical phased array.

FIG. 5 is a schematic diagram of an example of angular steering associated with radiation intensity patterns for optical phased arrays.

FIGS. 6A-6B are schematic diagrams of example grating antennas and plots of corresponding example far-field radiation patterns.

FIG. 7A are schematic diagrams of example arrangements of grating antennas and plots of corresponding example far-field radiation patterns.

FIGS. 7B-7D are schematic diagrams of example arrangements of grating antennas.

FIG. 8 is a schematic diagram of an example communication system.

FIG. 9 depicts plots of numerical simulations associated with configuring optical systems.

FIG. 10 is a schematic diagram associated with analyzing data.

### DETAILED DESCRIPTION

Some implementations of phased arrays can allow for the electronic steering of optical beams without moving parts. Some phased arrays comprise a plurality of antenna elements that are associated with an array factor, or a pattern of radiation. Interference between optical waves emitted from the plurality of antenna elements can determine a shape and directionality of an emitted optical beam. Some phased arrays can be configured to produce an optical beam having peaks of intensity, sometimes referred to as lobes, over a range of angular positions. A primary lobe, or main lobe, can be associated with a portion of an optical beam having a highest intensity. Some phased array implementations can generate grating lobes, or secondary lobes between main lobes, due to the finite array factor. Distinguishing between optical signals associated with main lobes and grating lobes can be useful in using phased arrays in optical systems.

Without using the methods disclosed herein, some systems can be configured such that grating lobes can be eliminated by very closely spacing individual antennas or antenna element. However, such implementations can be can be limited by crosstalk between antennas of the array. For frequency-modulated continuous wave (FMCW) LiDAR, amongst other applications, the grating lobes not only can represent a loss term, but also grating lobe back-reflections from strong reflectors can also confound the scene. To eliminate the back-reflection issue, receive apertures in bistatic LiDAR can be vernier-pitched with respect to the transmit aperture: while the main lobes are phased to the same point in the field-of-view (FOV), the grating lobes are misaligned. This configuration can remove the problematic grating lobe back-reflection, albeit at a loss of that light, which could be useful. In contrast, using the methods and techniques disclosed herein, a grating lobe can be captured and differentiated from the main lobe such that the lost light is recovered and the LiDAR scene is not confounded.

In some implementations, a phased array can comprise multiple apertures with one or more receive apertures having different element factors, i.e., asymmetric element factors, such that the one or more receive apertures are selectively more sensitive to portions of the FOV. The angular response in the phase axis of the receive array can then be used to differentiate between main lobe and grating lobes. In some implementations where the antenna pitch is close to but not less than the grating-free condition (λ/2<p≤λ), where λ is the wavelength of light and p is the antenna pitch, and FOV can comprise one grating lobe for any main-lobe angle. In some examples, a main lobe and each grating lobe can have a significant angular separation in the FOV such that each of the main lobe or the grating lobe can be more strongly detected by receive apertures whose element factor makes them more sensitive to that particular portion of the FOV. A further benefit of this implementation is that, while the main lobe scans across angles in the FOV, the grating lobe can simultaneously scan across extreme peripheral portions of the FOV. This configuration can both add parallelism to the system such that points-per-second is increased, as well as increase the usable FOV.

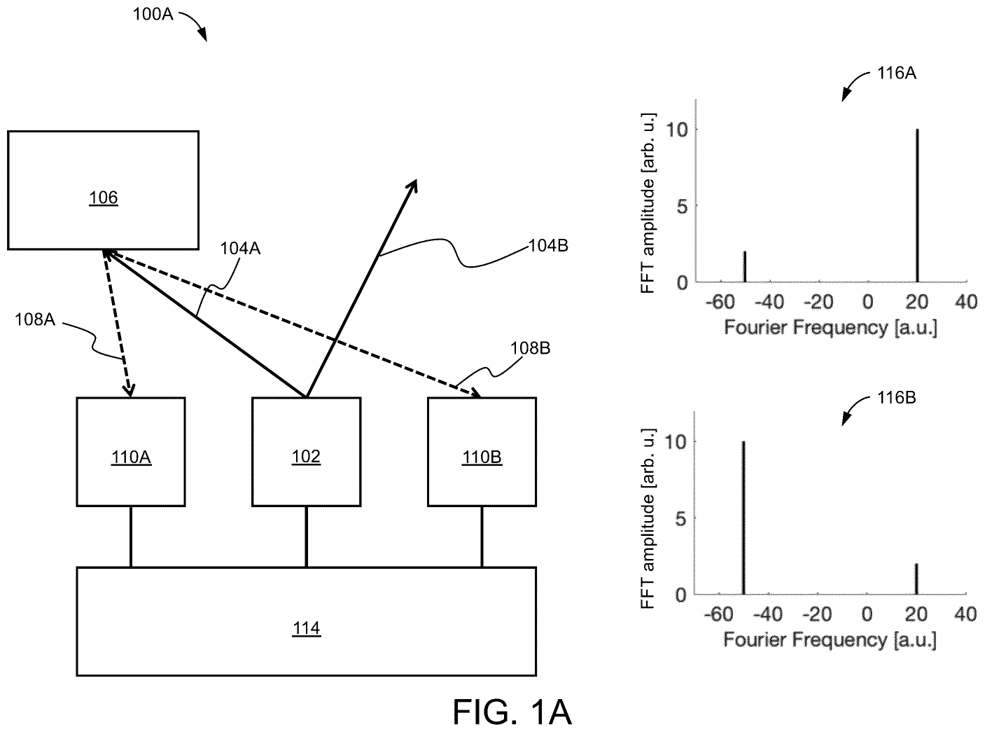

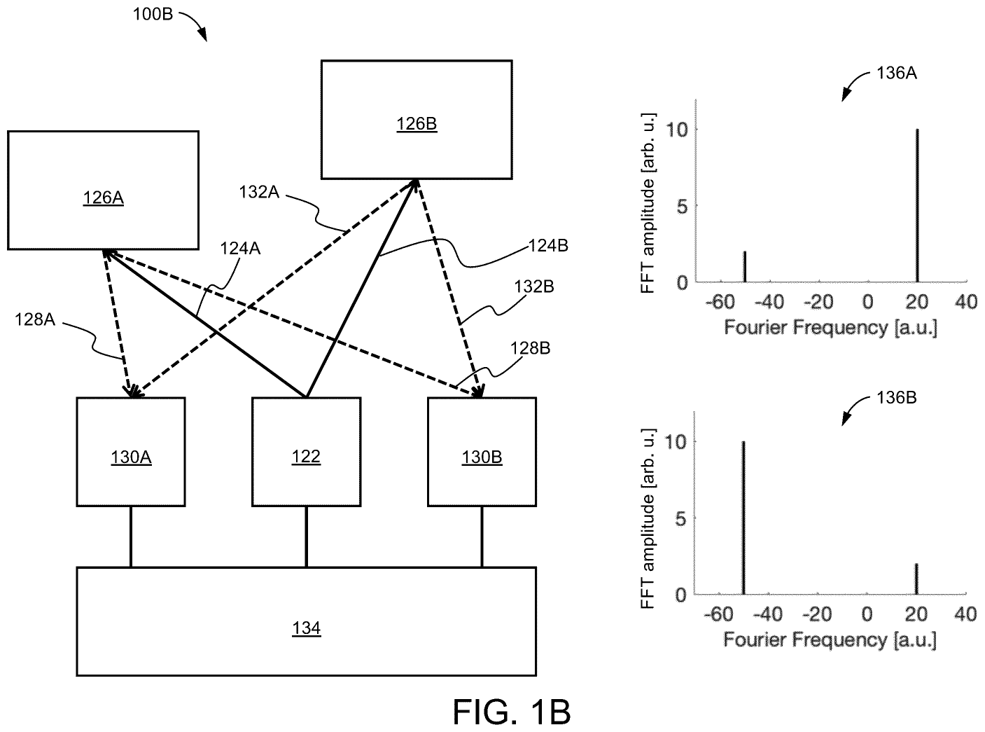

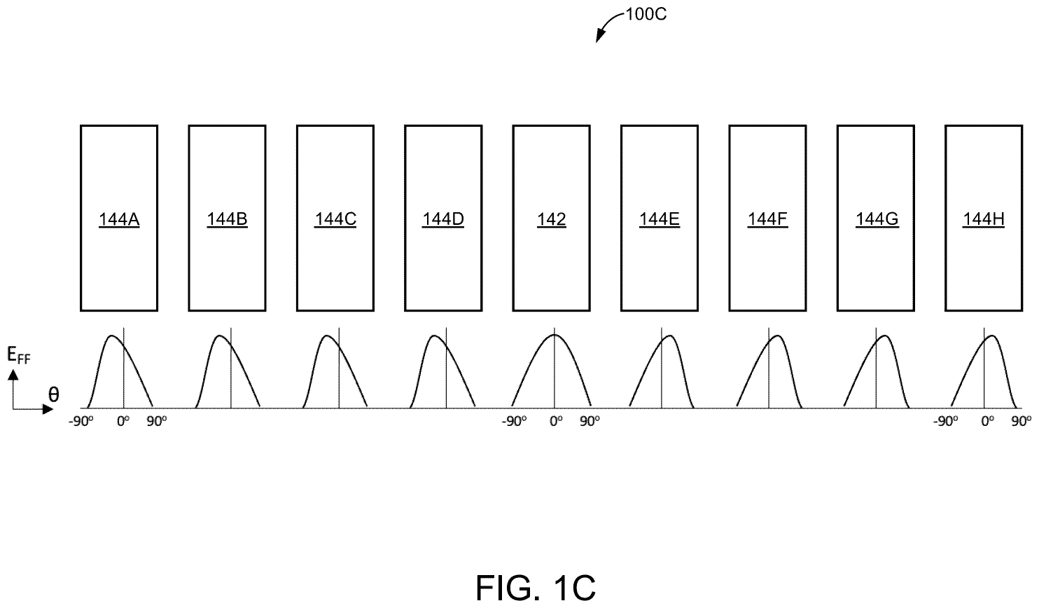

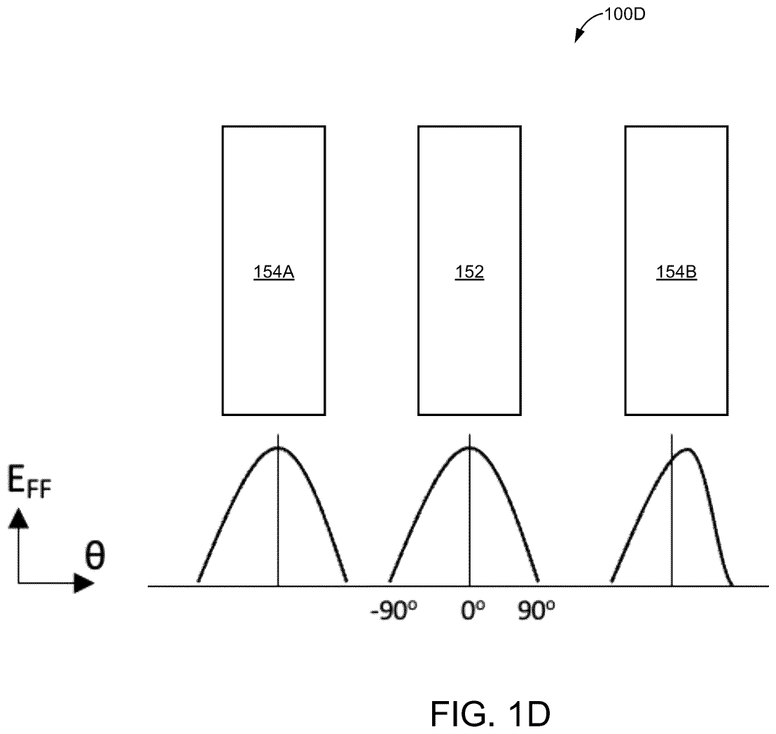

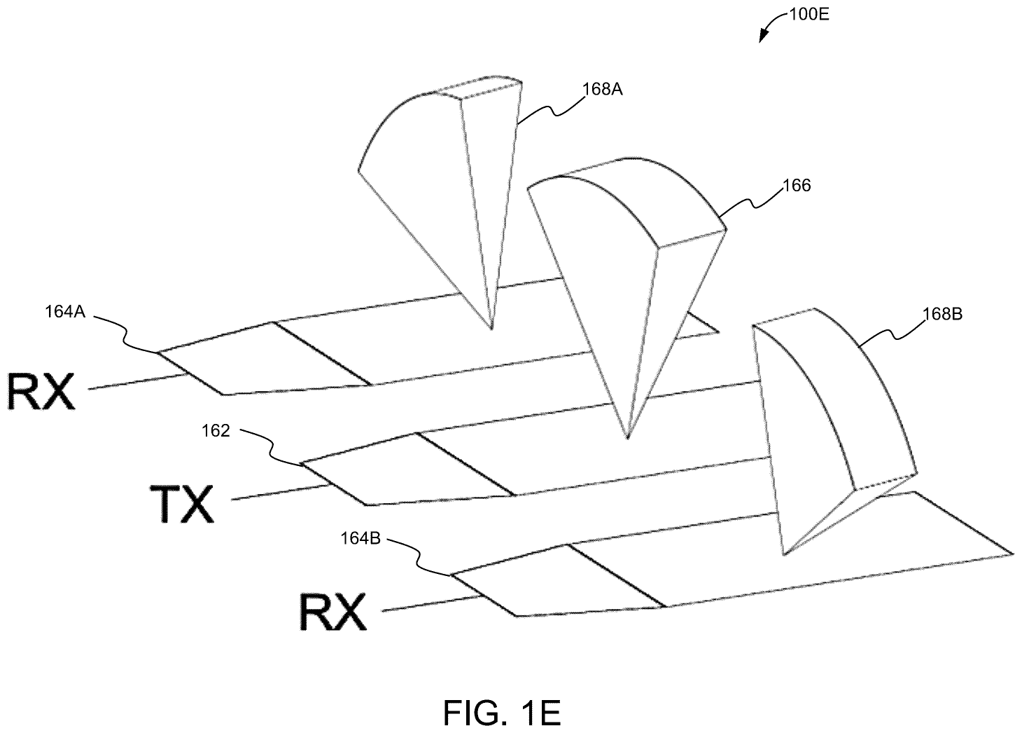

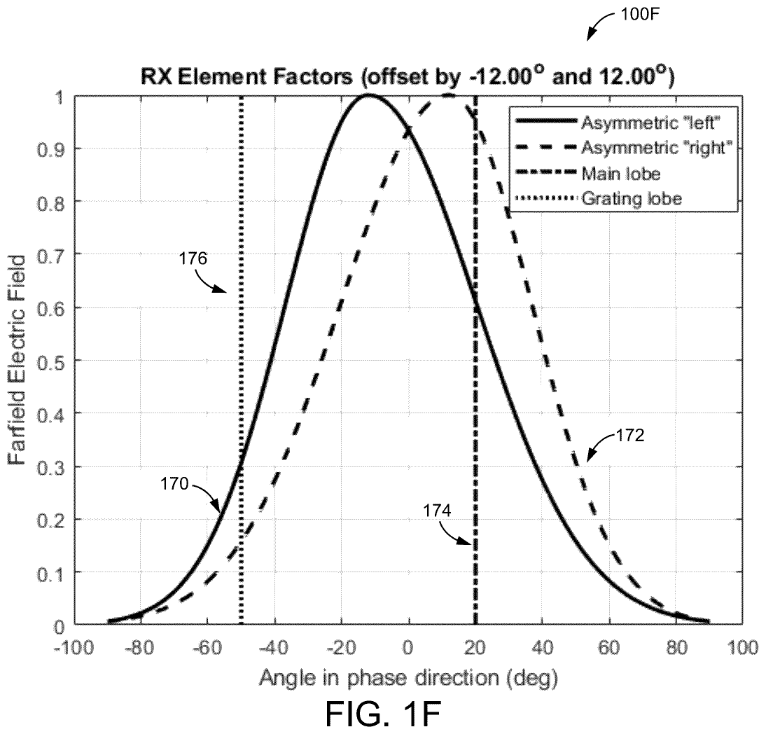

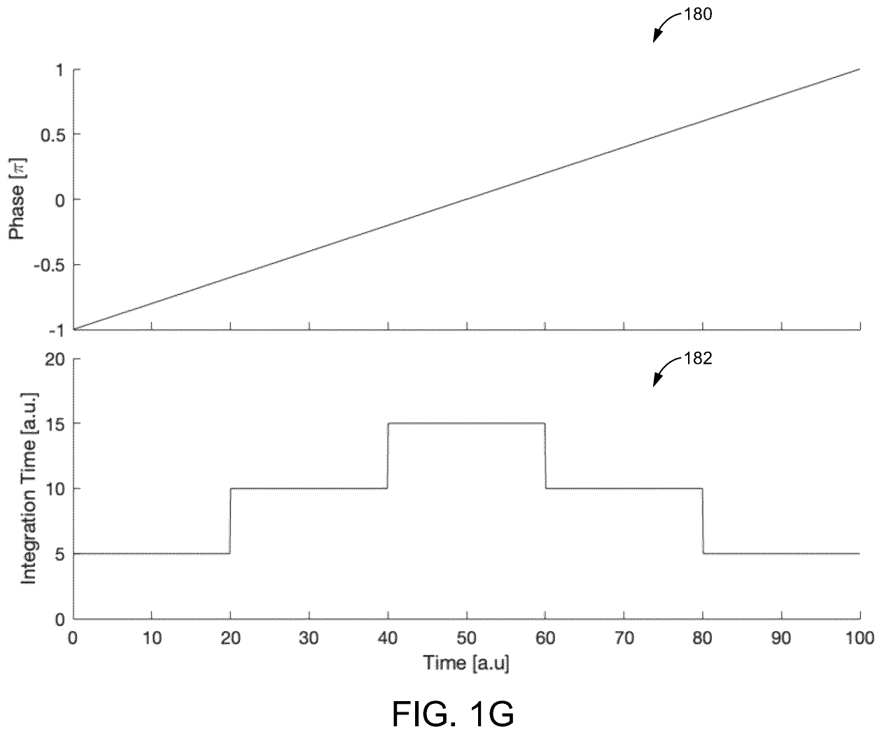

FIG. 1A depicts a schematic diagram of an example system 100A configured for side lobe recovery. In some implementations, the system 100A can be included in a LiDAR or RADAR system. A system can be implemented in various configurations, including as a single apparatus or as a combination of one or more apparatuses that collectively perform the functions of a system. In some examples, the one or more apparatuses can form a device, i.e., a system-on-a-chip, or the one or more apparatuses can be separate devices. The system 100A comprises a transmit aperture 102 configured to provide an optical beam comprising a first lobe 104A and a second lobe 104B, i.e., corresponding to far-field angular intensity patterns. In some examples, the second lobe 104B can be the main lobe of the optical beam while the first lobe 104A can be a side lobe of the optical beam. The first lobe 104A interacts with an object 106. In this example, the interaction results in backscattered, or reflected, optical beams. A portion 108A of the backscattered optical beam from the interaction of the first lobe 104A and the object 106 is collected by a first receive aperture 110A, while a portion 108B of the backscattered, or reflected, optical beam from the interaction of the first lobe 104A and the object 106 is collected by a second receive aperture 110B. The system 100A also comprises circuitry 114 configured to detect the collected portions and control each of the transmit aperture 102, the first receive aperture 110A, and the second receive aperture 110B. In some examples, the circuitry 114 can be configured to determine a position or speed of the object 106.

Each of the first receive aperture 110A and the second receive aperture 110B, i.e., at least two receive apertures, comprise a respective OPA with a plurality of antenna elements where the antenna elements of a particular OPA comprise a plurality of waveguides coupled to respective phase shifters and a respective plurality of grating elements arranged along each waveguide of the plurality of waveguides according to an element factor associated with the particular OPA. Schematic diagrams of example OPAs are depicted and described later. In this example, each OPA of the first receive aperture 110A and the second receive aperture 110B are associated with different respective element factors that correspond to different respective far-field angular intensity patterns. This configuration allows the system 100A to distinguish between the interaction of the first lobe 104A and the second lobe 104B with the object 106. By way of example, a plot 116A of numerical simulations of detected events following fast Fourier Transform (FFT) at the first receive aperture 110A and a plot 116B of numerical simulations of detected events following FFT at the second receive aperture 110B are shown in FIG. 1A. As shown in the plot 116A and the plot 116B, by distinguishing the weights of these events registered at the first receive aperture 110A and second receive aperture 110B using the circuitry 114, information such as position and speed associated with detection of the first lobe 104A and the second lobe 104B can be resolved. In some examples, the circuitry 114 can comprise digital signal processing (DSP) to determine this information based on detection and processing of the optical beams. In some examples, the positions of the first lobe 104A and the second lobe 104B can be relative such that the first lobe 104A and the second lobe 104B can be switched depending on the pointing angle. In some implementations, to further improve operating capabilities of a system such as accuracy, FOV, resolution and signal-to-noise ratio (SNR), the system can comprise multiple transmit apertures and receive apertures can be configured to have element factors that are the same or different.

In other words, the circuitry 114, i.e. a signal processing module, is configured to process optical signals received from the plurality of receive apertures, i.e., the first receive aperture 110A and the second receive aperture 110B, to resolve a detected event associated with either the first lobe 104A or the second lobe 104B of a far-field angular intensity pattern. In some examples, this processing can comprise comparing the portion 108A of the optical beam, or associated detected events, received at the first receive aperture 110A with the portion 108B of the optical beam, or associated detected events, received at a second receive aperture 110B.

In some implementations, a system can interact with more than one object. FIG. 1B depicts a schematic diagram of an example system 100B configured for side lobe recovery. In some implementations, the system 100B can be included in a LiDAR or RADAR system. The system 100B comprises a transmit aperture 122 configured to provide an optical beam comprising a first lobe 124A and a second lobe 124B, i.e., corresponding to far-field angular intensity patterns. In some examples, the second lobe 124B can be the main lobe of the optical beam while the first lobe 124A can be a side lobe of the optical beam. The first lobe 124A and the second lobe 124B interact with a first object 126A and a second object 126B, respectively. In this example, the interaction results in backscattered optical beams. A portion 128A of the backscattered optical beam from the interaction of the first lobe 124A and the first object 126A is collected by a first receive aperture 130A, while a portion 128B of the backscattered optical beam from the interaction of the first lobe 124A and the first object 126A is collected by a second receive aperture 130B. A portion 132A of the backscattered optical beam from the interaction of the second lobe 124B and the second object 126B is collected by the first receive aperture 130A, while a portion 132B of the backscattered optical beam from the interaction of the second lobe 124B and the second object 126B is collected by the second receive aperture 130B. The system 100B also comprises circuitry 134 configured to detect the collected portions and control each of the transmit aperture 122, the first receive aperture 130A, and the second receive aperture 130B. In some examples, the circuitry 134 can be configured to determine a position or speed of the first object 126A or the second object 126B.

Each of the first receive aperture 130A and the second receive aperture 130B, i.e., at least two receive apertures, comprise a respective OPA with a plurality of antenna elements where the antenna elements of a particular OPA comprise a plurality of waveguides coupled to respective phase shifters and a respective plurality of grating elements arranged along each waveguide of the plurality of waveguides according to an element factor associated with the particular OPA. Schematic diagrams of example OPAs are depicted and described later. In this example, each OPA of the first receive aperture 130A and the second receive aperture 130B are associated with different respective element factors that correspond to different respective far-field angular intensity patterns. This configuration allows the system 100B to distinguish between the interaction of the first lobe 124A and the second lobe 124B with the first object 126A and the second object 126B. By way of example, a plot 136A of numerical simulations of detected events following fast Fourier Transform (FFT) at the first receive aperture 130A and a plot 136B of numerical simulations of detected events following FFT at the second receive aperture 130B are shown in FIG. 1B. As shown in the plot 136A and the plot 136B, by distinguishing the weights of these events registered at the first receive aperture 130A and second receive aperture 130B using the circuitry 134, information such as position and speed associated with detection of the first lobe 124A and the second lobe 124B can be resolved. In some examples, the circuitry 134 can comprise digital signal processing (DSP) to determine this information based on detection and processing of the optical beams. In some examples, the positions of the first lobe 124A and the second lobe 124B can be relative such that the first lobe 124A and the second lobe 124B can be switched depending on the pointing angle. In some implementations, to further improve operating capabilities of a system such as accuracy, FOV, resolution and signal-to-noise ratio (SNR), the system can comprise multiple transmit apertures and receive apertures can be configured to have element factors that are the same or different.

In other words, the circuitry 134, i.e. a signal processing module, is configured to process optical signals received from the plurality of receive apertures, i.e., the first receive aperture 130A and the second receive aperture 130B, to resolve a detected event associated with both of the first lobe 124A and the second lobe 124B of a far-field angular intensity pattern. In some examples, this processing can comprise comparing the portion 128A of the optical beam, or associated detected events, received at the first receive aperture 130A with the portion 128B of the optical beam, or associated detected events, received at a second receive aperture 130B. The processing can further comprise comparing the portion 132A of the optical beam, or associated detected events, received at the first receive aperture 130A with the portion 132B of the optical beam, or associated detected events, received at a second receive aperture 130B.

In some examples, distinguishing whether an object has interacted with a first lobe or a second lobe of a transmitted optical beam can be associated with ambiguity errors, where a system incorrectly identifies spatial locations of objects. Using the methods disclosed herein, ambiguity errors can be reduced.

FIG. 1C depicts a schematic diagram of an example system 100C comprising a transmit aperture 142 and a plurality of receive apertures 144A-144H, i.e., a receive aperture 144A, a receive aperture 144B, a receive aperture 144C, a receive aperture 144D, a receive aperture 144E, a receive aperture 144F, a receive aperture 144G, and a receive aperture 144H. In this example, an optical beam or light can be sent to a far-field target by the transmit aperture 142. The scattered optical beam by a target in the far-field can be collected by the plurality of receive apertures 144A-144H. Each of the transmit aperture 142 and each receive aperture of the plurality of receive apertures 144A-144H comprises a respective OPA that is associated with a respective element factor. Each element factor is associated with a respective far-field angular intensity pattern, as shown by the example electric field plots underneath the apertures. As shown by the electric field plots, the transmit aperture 142 is associated with a far-field angular intensity pattern, which can be represented as a symmetric Gaussian function relative to a vertical line. Each receive aperture of the plurality of receive apertures 144A-144H is associated with a different respective far-field angular intensity pattern, which can be represented as an asymmetric Gaussian function. In other words, each receive aperture of the plurality of receive apertures 144A-144H is sensitive to different regions of the FOV. In this example, the receive apertures 144A-144D are left-facing, i.e., the respective asymmetric Gaussian functions skew left relative to the vertical line, while the receive apertures 144E-144H are right-facing, i.e., the respective Gaussian functions skew right relative to the vertical line. In some implementations, configuring the plurality of receive apertures 144A-144H as depicted can be associated with improved speckle diversity.

As shown in FIG. 1C, each of the far-field angular intensity patterns of the plurality receive apertures 144A-144H at least partially overlap with the far-field angular intensity pattern of the transmit aperture 142. Further, the far-field angular intensity patterns of any two receive apertures of the plurality of receive apertures 144A-144H at least partially overlap with each other.

In some examples, an aperture can be configured to have an asymmetric element factor associated with an OPA. Some asymmetric element factors can be associated with varying amounts of electric field (EFF) to the far-field θ, as shown by the skewed or asymmetric Gaussian functions in FIG. 1C. As depicted and described later, some OPAs can comprise splayed antenna elements to such that the OPA is associated with an asymmetric element factor. Some systems can comprise an arbitrary number of transmit and receive apertures. In some implementations, the element factor of the transmit aperture can also be tilted.

In some examples, a system can be configured such that a first receive aperture can be configured to have a symmetric element factor while a second receive aperture can have an asymmetric element factor. FIG. 1D depicts a schematic diagram of an example system 100D comprising a transmit aperture 152 and a plurality of receive apertures 154A-154B, i.e., a receive aperture 154A and a receive aperture 154B. In this example, an optical beam or light can be sent to a far-field target by the transmit aperture 142. The scattered optical beam by a target in the far-field can be collected by the plurality of receive apertures 154A-154B. Each of the transmit aperture 152 and each receive aperture of the plurality of receive apertures 154A-154B comprises a respective OPA that is associated with a respective element factor. Each element factor is associated with a respective far-field angular intensity pattern, as shown by the example electric field plots underneath the apertures. As shown by the electric field plots, the transmit aperture 152 and the receive aperture 154A are each associated with a far-field angular intensity pattern, which can be represented as a symmetric Gaussian function relative to a vertical line. The receive aperture 154B is associated with a different respective far-field angular intensity pattern than the receive aperture 154A. In this example, the receive aperture 154B is associated with a far-field angular intensity pattern represented as an asymmetric Gaussian function.

FIG. 1E shows a schematic diagram of an example system 100E comprising a transmit aperture 162, a first receive aperture 164A, and a second receive aperture 164B and depicts the tilting of emission and receiving angles associated with a lobe of an optical beam. The transmit aperture 162 emits optical beam 166. The first receive aperture 164A receives optical beam 168A and the second receive aperture 164B receives optical beam 168B. In this example, the transmit aperture 162 has an element factor such that the optical beam 166 is emitted upwards. The first receive aperture 164A has an element factor such that the received, or collected, optical beam 168A is pointed left while the second receive aperture 164B has an element factor such that the received optical beam 168B is pointed right. In this example, first receive aperture 164A and the second receive aperture 164B receive optical beams that at least partially overlap. Some systems can comprise transmit apertures and receive apertures that are tilted at arbitrary angle to achieve the best result for a specific application.

In some implementations, using Gaussian functions, i.e., asymmetric or symmetric Gaussian functions, to represent element factors associated with receive apertures can allow a LiDAR system to be more sensitive at large, peripheral angles, thus extending the usable system FOV. Some systems can be configured such that a main lobe can be distinguished from a grating lobe by taking the ratio of the angular response function of the distinct receive apertures. In some examples, if a detection is registered more strongly by one or more apertures sensitive to one portion of the FOV, and less strongly by other receive apertures sensitive to another portion of the FOV, a system can determine from which portion of the FOV the light has propagated, i.e., the main lobe and grating lobe can be delineated.

FIG. 1F depicts a plot 100F of numerical simulations associated with an optical system. Specifically, FIG. IF depicts far-field electric fields as a function of angle for a receive aperture configured according to the example far-field intensity pattern represented by the solid trace 170 and a receive aperture configured according to the example far-field intensity pattern represented by the dashed trace 172. Each receive aperture is configured according to a respective element factor, in this example, both receive apertures are configured according to asymmetric element factors. Also depicted in FIG. 1F is the far-field angle at which a main lobe, represented by the dot-dashed trace 174, i.e., the vertical trace, and a grating lobe associated with the main lobe, represented by the vertical dotted trace 176, may appear in the far-field. The main lobe and the grating lobe can be associated with a phased array of nominal pitch p (λ/2<p≤λ). A phased array can be a spatial convolution of an individual antenna element factor with the array factor and can have a far-field emission pattern given by the multiplication of the respective far-field patterns of the element and array factors. In this non-limiting example, the main lobe can be detected more strongly by those receive apertures having “right” asymmetric element factor, as represented by the dashed trace 172, and less so by those with “left” asymmetric element factor, as represented by the solid trace 170. In other words, the main lobe represented by the dot-dashed trace 174 intersects with the dashed trace 172 at a higher value than the value at which the dot-dashed trace 174 intersects with the solid trace 170. In practical settings, this overlap can manifest as a difference in signal amplitude. The reverse trend can true for the detection of the grating lobe, i.e., the receiver aperture configured according the far-field intensity profile represented by the solid trace 170 can detect the grating lobe more strongly than the receiver aperture configured the far-field intensity profile represented by the dashed trace 172. A main lobe and a grating lobe can be distinguished by taking the relative response of the different asymmetric receive apertures, i.e., the amplitude of the signal arriving at each receive aperture. Although Gaussian profile is used as an example here, an arbitrary element factor profile can be engineered to improve the detection efficiency.

FIG. 1G depicts a plot 180 and a plot 182 of numerical simulations associated with an optical system and demonstrate how adaptive integration time can improve SNR on sidelobe detection and enable wide FOV. The plot 180 depicts phase as a function of measurement time for an example LiDAR system while the plot 182 depicts integrated time as a function of measurement time for an example optical system. When the sidelobe is at low power, the integration time can be increased to improve the detection efficiency, and vice versa. This method can help mitigate the total measurement time to effectively improve the resolution of detection.

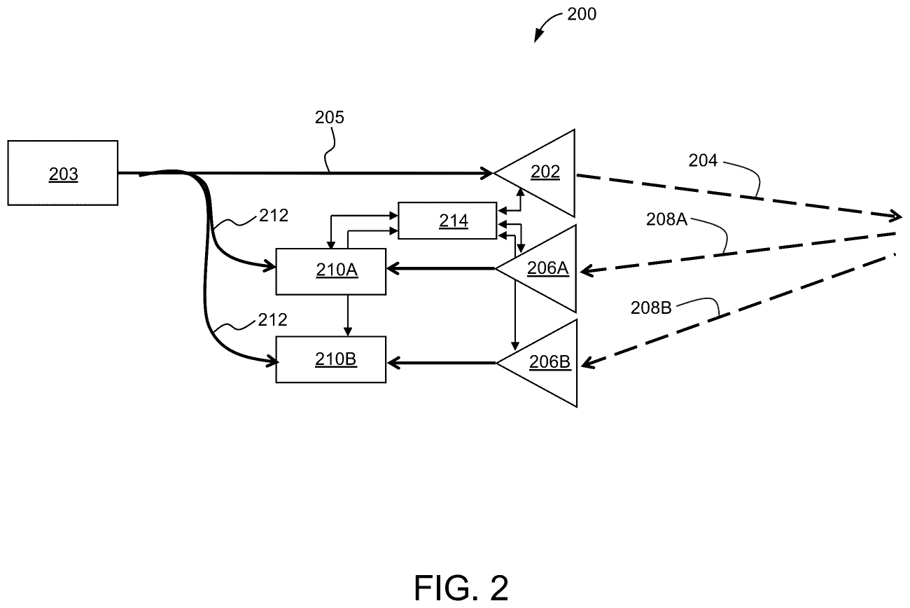

FIG. 2 shows an example of a system 200, i.e., a LiDAR system, in which some of the sidelobe recovery techniques can be used. The system 200 uses a configuration that can include one or more transmitter (Tx) antenna modules and one or more receiver (Rx) antenna modules. For example, some implementations are configured to use separate Tx and Rx antenna modules, where the separate antenna modules provide a separate transmitting aperture and receiving aperture (i.e., in a bistatic arrangement). In other implementations, an antenna module can be configured to operate in both a transmitter (Tx) mode of operation and a receiver (Rx) mode of operation (i.e., in a monostatic arrangement) where the transmitting aperture and the receiving aperture are the same. In the example of FIG. 2, the system 200 includes a transmitter antenna module 202 that transmits an optical beam 204 at an angle that can be steered over a steering range, and a first receiver antenna module 206A and a second receiver antenna module 206B that can each be controlled to receive light incoming from a particular angle (i.e., a multi-static arrangement). For example, the first receiver antenna module 206A can be configured to receiving incoming light 208A including a portion of the optical beam 204 backscattered from a target object or region, and the second receiver antenna module 206B can be configured to receive incoming light 208B including a portion of the optical beam 204 backscattered from the target.

The system includes an optical source 203 that provides an optical wave 205 to the transmitter antenna module 202. In some implementations, the optical source 203 is a continuous wave (CW) coherent light source (e.g., a laser) that provides an optical wave that has a narrow linewidth and low phase noise, for example, sufficient to provide a temporal coherence length that is long enough to perform coherent detection over the time scales of interest. In some implementations, the optical source 203 is a frequency tunable laser system in which the frequency of the light provided can be swept to perform frequency modulated continuous wave (FMCW) LiDAR measurements. Coherent receiver modules 210A and 210B receiving collected light from the first receiver antenna module 206A and the second receiver antenna module 206B, respectively, are configured to coherently mix the collected light with light of a local oscillator (LO) 212, which can be derived from the optical source 203 or from a portion of the optical wave 205 provided to the transmitter antenna module 202. A photodetection system, such as a balanced detector or an in-phase/quadrature-phase (IQ) detector, can be used to obtain one or more electrical signals representing the strength of a beat signal that has a maximum amplitude when the frequency of the LO and the received light are substantially equal.

A control module 214 is configured to control various aspects of the antenna modules and coherent receiver modules to determine information about a target object associated with a detection event based at least in part on one or more characteristics of the received backscattered light. In addition to a location of a target object that has backscattered light, there may also be range information characterizing a distance to the target object, and/or velocity information characterizing a relative speed of the target object, that can be obtained based at least in part on a frequency chirp (e.g., a linear chirp) that is applied to the optical wave 205 generated by the optical source 203. The control module 214 can include electronic circuitry (e.g., application specific integrated circuit, and/or processor cores), and in some cases is integrated on the same photonic integrated circuit including the antenna modules or on an electronic integrated circuit mounted to the photonic integrated circuit including the antenna modules.

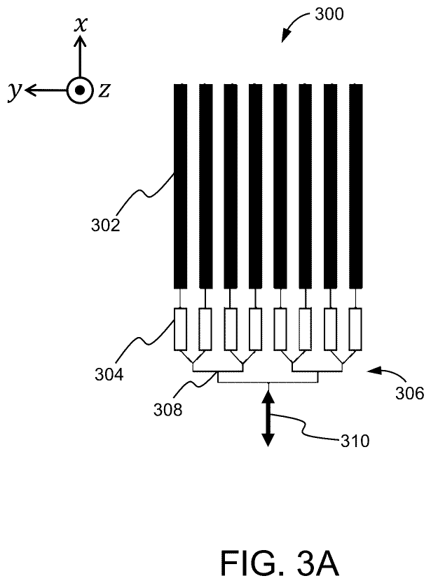

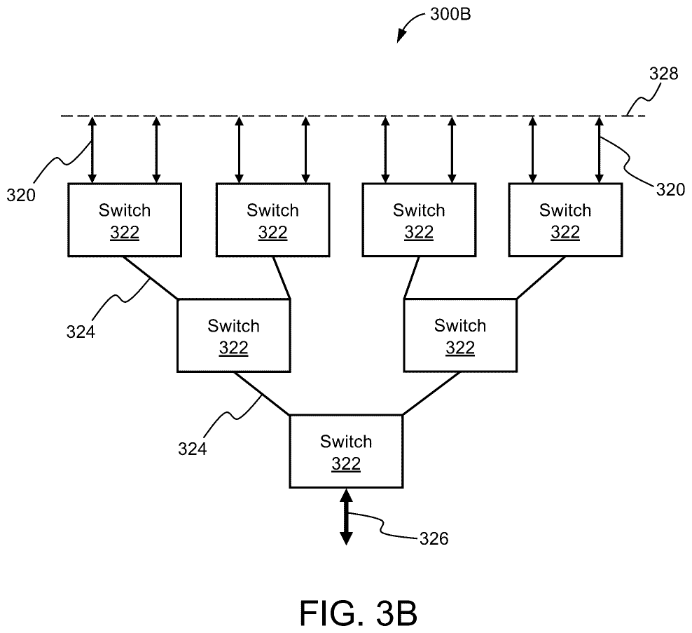

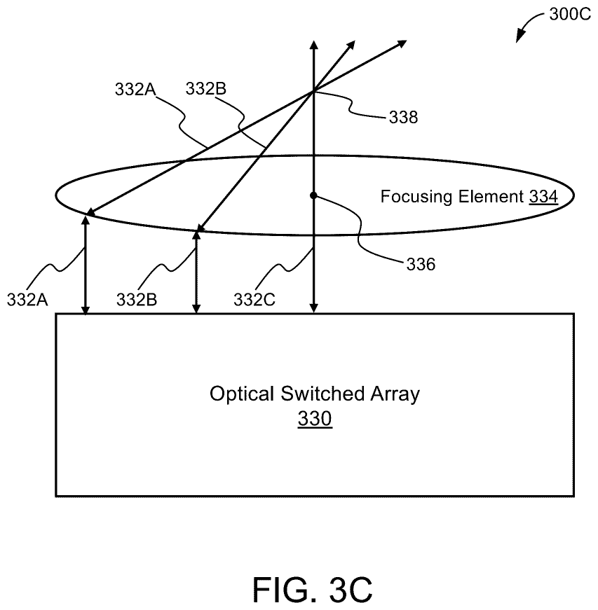

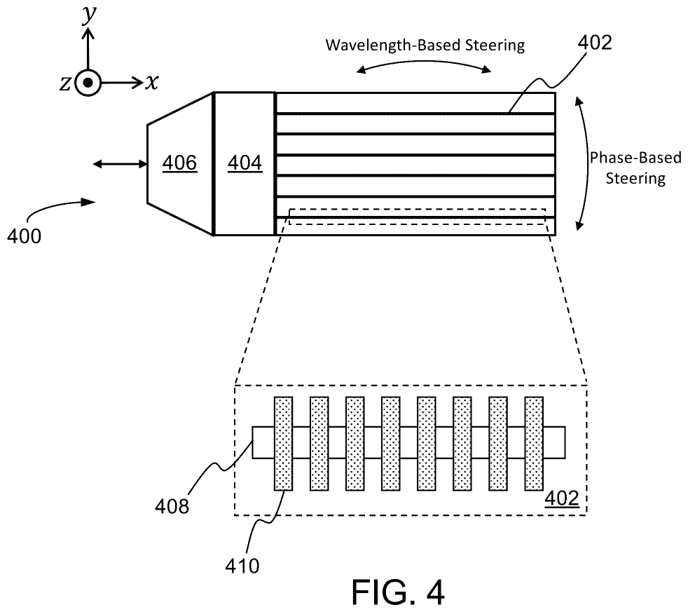

Any of a variety of techniques can be used to steer the transmission angle of the optical beam 204 provided by the transmitter antenna module 202 over a steering range, and to steer the reception angle of the first receiver antenna module 206A and the second receiver antenna module 206B. In some implementations, an OPA is used to enable steering of a lobe of a radiation intensity pattern (also referred to as a gain pattern) associated with the OPA. Some OPAs have a linear distribution of optical antennas. Steering about a first axis perpendicular to the linear distribution can be provided, for example, by changing the relative phase shifts in phase shifters coupled to each of the optical antennas. For example, FIG. 3A shows an example OPA 300 that includes an array of optical antennas 302. Light can be emitted from (and/or received into) optical antennas 302 from different emission planes depending on the type of optical antennas being used. For a grating-antenna-based OPA, each optical antenna is configured as an optical grating, as described in more detail in FIG. 4, and power from individual optical waves is emitted gradually over the length of the optical gratings over an emission plane in the plane of the page in FIG. 3A (the x-y plane). Alternatively, for an end-fire-antenna-based OPA, each optical antenna is configured to emit light from the ends of the optical antennas at an emission plane that is perpendicular to the plane of the page in FIG. 3A (the y-z plane). In either case, the optical waves optically interfere with each other starting at the emission plane to form an optical phased array output beam when the OPA 300 is used as a transmitter. The direction of peak constructive interference depends on the relative phase shifts imposed on light entering the optical antennas.

The OPA 300 includes an array of optical phase shifters 304 that impose respective phase shifts on optical waves provided as phase shifted optical waves entering the respective optical antennas 302 when the OPA is used as a transmitter, or on optical waves that have been collected by respective optical antennas 302 when the OPA is used as a receiver. The optical phase shifters 304 can be, for example, electro-optic, thermal, liquid crystal, pn junction phase shifters. In some examples, each of the optical phase shifters 304 is controlled independently, while in other examples two or more of the optical phase shifters 304 may be jointly controlled. An optical coupler 306 is configured to couple an optical port 310 to the array of optical phase shifters 304. In this example, the optical coupler 306 is in the form of a power splitting network formed form interconnected power splitters 308. In this example, the power splitters 308 are 1×2 power splitters (also referred to as 50/50 power splitters) and are interconnected by waveguides in a binary tree arrangement to achieve substantially equal power into each optical phase shifter 304 from an input optical wave entering the optical port 310 when the OPA 300 is used as a transmitter (Tx operation), and to provide substantially equal path lengths between each optical phase shifter 304 and the optical port 310. When the OPA 300 is used as a receiver (Rx operation), the light received by the optical antennas 302 and phase shifted by the optical phase shifters 304 is combined into an output optical wave at the optical port 310, which can then be further manipulated, transformed, or measured.

FIG. 3B shows an optical switched array 300B comprising an array of optical antennas 320 (e.g., waveguide facets in an end-fire configuration, optical gratings, plasmonic emitters, metal antennas, and mirror facets). The optical switched array 300B is arranged in a tree-like structure comprising a plurality of optical switches 322 optically interconnected via waveguides 324. In some examples, each optical switch of the plurality of optical switches 322 can be Mach-Zehnder interferometers or another kind of optical switch. Each optical switch of the plurality of optical switches 322 may be controlled in response to one or more applied voltages, allowing the plurality of optical switches 322 to direct light at a first switch port to a second switch port and a third switch port in a tunable ratio (e.g., 50/50, 0/100, 25/75). Accordingly, the plurality of optical switches 322 can be configured (e.g., by applied voltages) to open select optical pathways between an optical port 326 and the array of optical antennas 320. For example, by applying suitable (possibly time-varying) voltages, the optical switched array 300B can provide light (e.g., emitted from a laser) from the optical port 326 to one or more of the optical antennas 320. In another example, by applying suitable voltages, the optical switched array 300B can provide light received by one or more of the optical antennas 320 to the optical port 326. In an example that uses an end-fire configuration, light is transmitted from or received into the optical antennas 320 at facets distributed over an edge 328 along which the optical antennas 320 are arranged. In general, each optical switch of the plurality of optical switches 322 may have slightly different voltage requirements for power switching between their ports. Furthermore, one or more optical switches of the plurality of optical switches 322 may be electrically interconnected to allow for joint voltage control, possibly reducing the number of voltage sources used.

Referring again to FIG. 3B, each optical switch of the plurality of optical switches 322 is configured in a 1×2 (i.e., one port by two ports) arrangement, however, other arrangements (e.g., 1×3, 1×4, 2×2, or 2×3) and mixtures of arrangements may also be utilized. The one or more switch types in an optical switched array need not all be of the same type or of the same technology (e.g., thermo-optic or electro-optic switches). A portion or all of the optical switched array 300B may be formed as part of a PIC.

In some LiDAR system configurations, an external optical element such as a focusing element may be used to steer the light from the optical switched array system in one dimension. FIG. 3C shows an example optical switched array system 300C that performs 1D-beam-steering. The optical switched array system 300C comprises an optical switched array 330. The optical switched array 330 (e.g., the optical switched array 300B shown in FIG. 3B) can selectively output a first optical beam 332A, a second optical beam 332B, and/or a third optical beam 332C. In general, the optical switched array 330 can output many optical beams. Each optical beam 332A-332C traverses a focusing element 334 (e.g., a lens) that converts a lateral displacement between the respective optical beam 332A-332C and a center 336 of the focusing element 334 into an angular displacement. In this example, each optical beam 332A-332C orthogonal to the surface of the focusing element 334 intersects at a point 338 (e.g., a focus of a lens). For example, the first optical beam 332A has a larger lateral displacement from the center 336 of the focusing element 334 than the second optical beam 332B, resulting in the first optical beam 332A having a larger angular displacement with respect to its optical path prior to traversing the focusing element 334 than the second optical beam 332B. Since the third optical beam 332C is orthogonal to the surface of the focusing element 334 and has no lateral displacement from the center 336 of the focusing element 334, the third optical beam 332C has no angular displacement.

FIG. 4 shows an example of a grating-antenna-based OPA 400 that is configured for phase-based steering about the x axis and wavelength-based steering about the y axis. For example, when configured for Tx operation, optical waves propagate along optical grating antennas 402 (along the x axis), and light is perturbed and gradually emitted from various locations over the x-y emission plane. With this two-dimensional (2D) steering configuration, steering can be performed along transverse (e.g., polar and azimuth) angular directions in a polar coordinate system, with the steering in one angular direction being performed by phase shifters in a phase shifter (PS) module 404 and the steering in the other angular direction being performed by wavelength of an optical wave distributing optical power via an optical coupler 406. The adjustment of the transmission angle for the Tx operation and collection angle for the Rx operation in the phase-controlled angular direction can be dynamically performed as the phases imposed by the phase shifters in the PS module 404 can be quickly tuned. Each optical grating antenna 402 is formed from a waveguide 408 and grating elements 410 arranged periodically along the waveguide 408 with a particular pitch pl (e.g., a constant spacing between grating elements 410) to perturb the guided optical wave causing emission in the direction of the grating elements 410. The angle at which the light is emitted from each optical grating antenna 402 depends on a relationship between the pitch p1 and the wavelength, and thus can be steered by changing the wavelength.

The PS module 404 can also be configured to provide focusing. For example, the emitted light can have a nonlinear phase front imposed on it by the phase shifters in the PS module 404 for focusing in Tx operation. This dynamically adjusted phase front can also tune the focal depth for Rx operation. Other techniques can be used for steering about a second axis orthogonal to the phase-based steering axis (e.g., mechanical based steering), such as when wavelength-based steering is not used for an optical grating antenna, or when an end-fire optical antenna is used.

In other words, the OPA 400 comprises a plurality of antenna elements where the antenna elements of the OPA 400 comprises a plurality of waveguides coupled to respective phase shifters, and a plurality of grating elements arranged along each of the waveguides according to an element factor associated with the particular OPA.

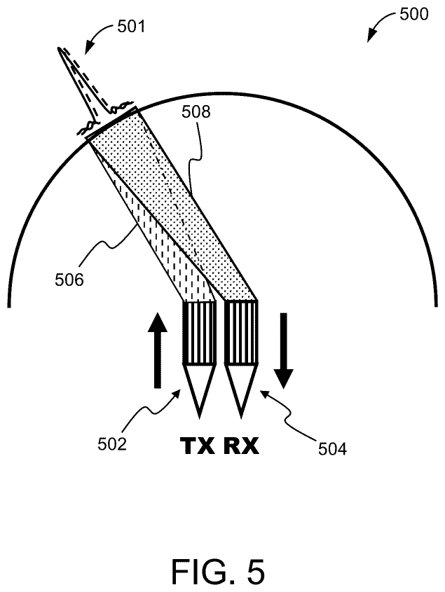

FIG. 5 shows an example LiDAR system 500 producing radiation intensity patterns 501 associated with a transmitter OPA 502 and a receiver OPA 504. In this example, main lobes associated with a transmitter radiation pattern 506 and a receiver radiation pattern 508 overlap. Such an arrangement of main lobe overlap can result, for example, from tuning phase shifters associated with transmitter and receiver optical antennas in the respective OPAs. Backscattered light from a target object situated near the main lobes is received by the receiver OPA 504. In each radiation intensity pattern, there may be a main lobe and additional grating lobes that occur on each side of the main lobe due to the limit in how close adjacent optical antennas can be in an OPA, which may limit the phase-based angular tuning range. In some implementations, the examples described herein may be designed to operate over a predetermined range of optical wavelengths such as, for example, the λ=1500 to 1600 nm band or the λ=1270 to 1330 nm band, and the pitch p corresponding to a distance between adjacent optical antennas may be of similar magnitude to the optical wavelength to increase the spacing between grating lobes (and thereby increase tuning range), or in some cases less than half of the optical wavelength to avoid grating lobes. For example, for operation in the 1500 to 1600 nm band, 700 nm≤p≤4000 nm may be typical.

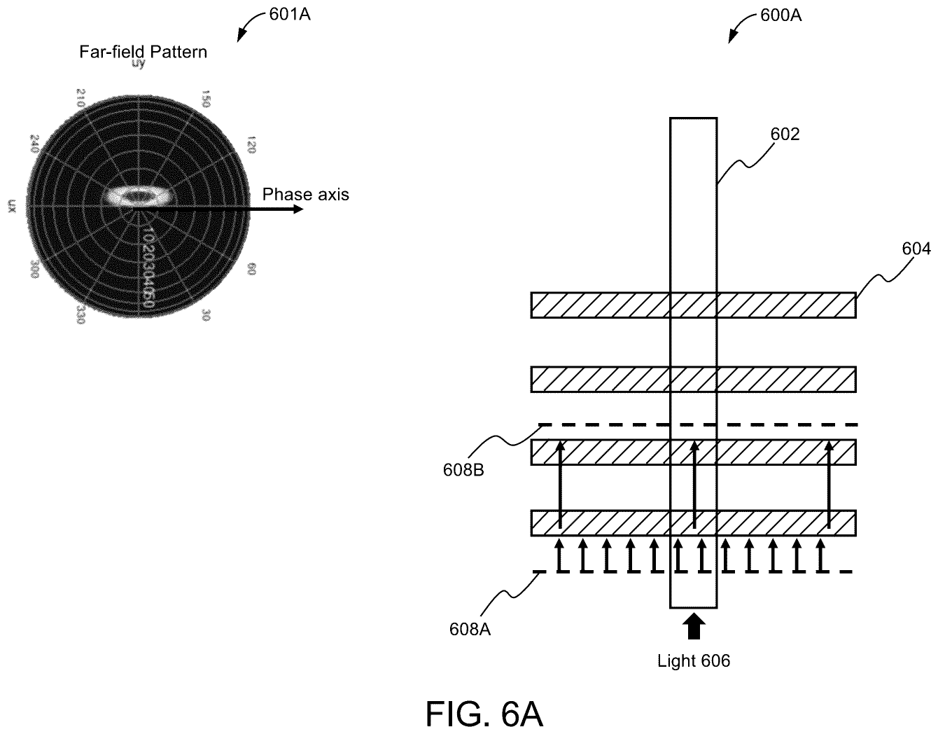

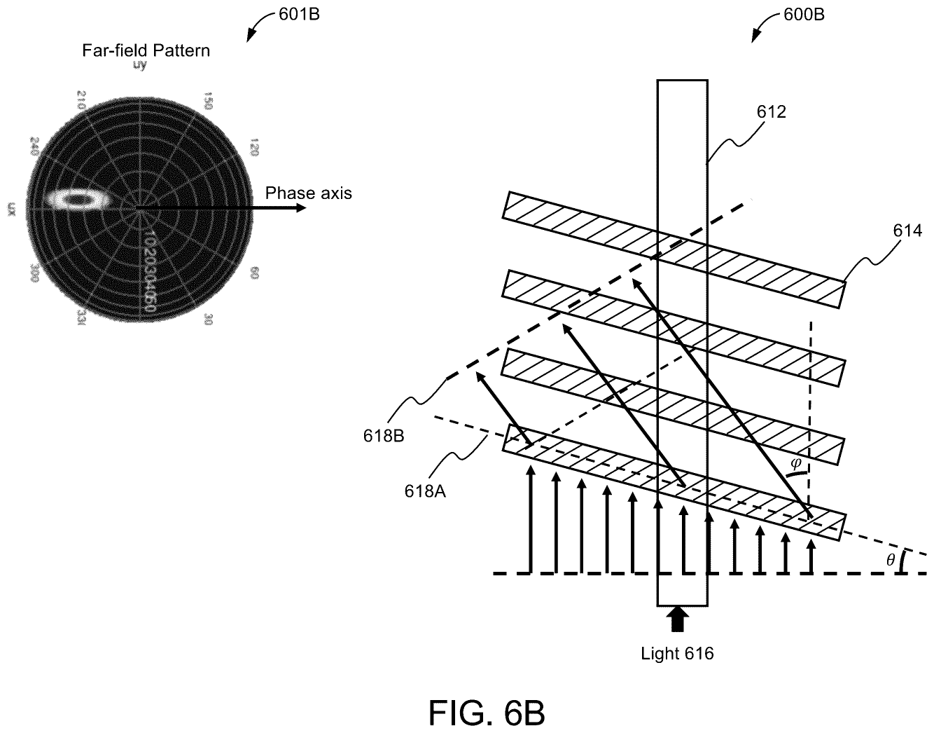

As previously described, some grating elements can be arranged along a waveguide of an OPA according to an element factor. In some examples, an element factor of an OPA can be associated with a far-field angular intensity pattern of an optical beam emitted from the OPA. FIG. 6A shows an example grating antenna 600A and a plot of a corresponding example far-field radiation pattern 601A. The grating antenna 600A comprises a waveguide 602 and grating elements 604 arranged orthogonal to the propagation axis of the waveguide 602. Thus, light 606 with a flat first wavefront 608A can not be angularly deflected such that the light 606 remains flat after propagating through the grating elements 604, resulting in a flat second wavefront 608B. The far-field radiation pattern 601A is substantially centered about 0 degrees on the phase-axis. In other words, the grating elements 604 of the grating antenna 600A are arranged in a normal configuration, i.e., non-splayed or angled substantially perpendicular to the waveguide 602. Such configurations can be associated with symmetric element factors.

FIG. 6B shows an example grating antenna 600B and a plot of a corresponding example far-field radiation pattern 601B. The grating antenna 600B comprises a waveguide 612 and grating elements 614 arranged non-orthogonal to the propagation axis of the waveguide 612. Thus, light 616 with a flat first wavefront 618A can have different connected portions of one of the grating elements 614 perturb different portions of the flat first wavefront 618A at different locations along the propagation axis, and can be associated with an angular deflection of φ and can remain flat after propagating through the grating elements 614, resulting in a flat second wavefront 618B propagating at a non-zero angle with respect to the phase-axis. The far-field radiation pattern 601B can thus be substantially displaced from the center (0 degrees) of the phase-axis. In other words, the grating elements 614 of the grating antenna 600B are arranged in a splayed configuration, i.e., the grating elements 614 are angled such that the grating elements 614 are not perpendicular to the waveguide 612. Such configurations can be associated with asymmetric element factors.

The grating antennas depicted in FIGS. 6A-6B provide an example of a possible approach to achieve tilted antenna element factor but the actual application is not necessarily limited to this method, especially in phased array RADAR. The normal antenna can have the antenna elements placed perpendicular to the waveguide and has a symmetric element factor with the maxima pointing perpendicular to the x axis. The splay antenna comprises antenna elements that are placed at an arbitrary angle, which can give rise to an asymmetric element factor with the maxima pointing at an angle in reference to x axis.

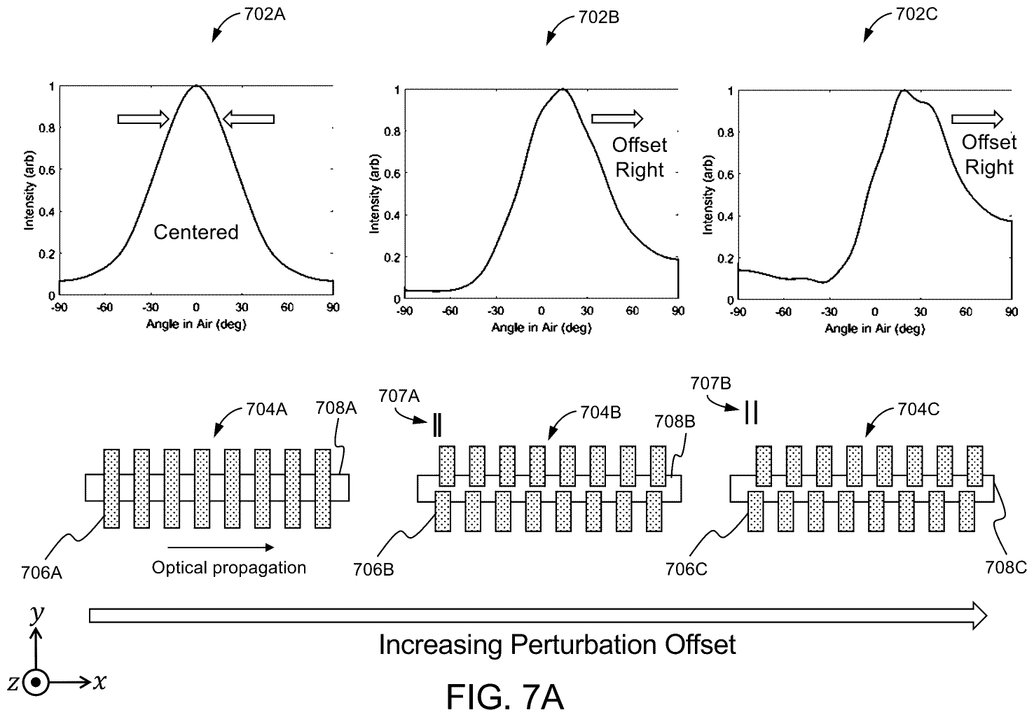

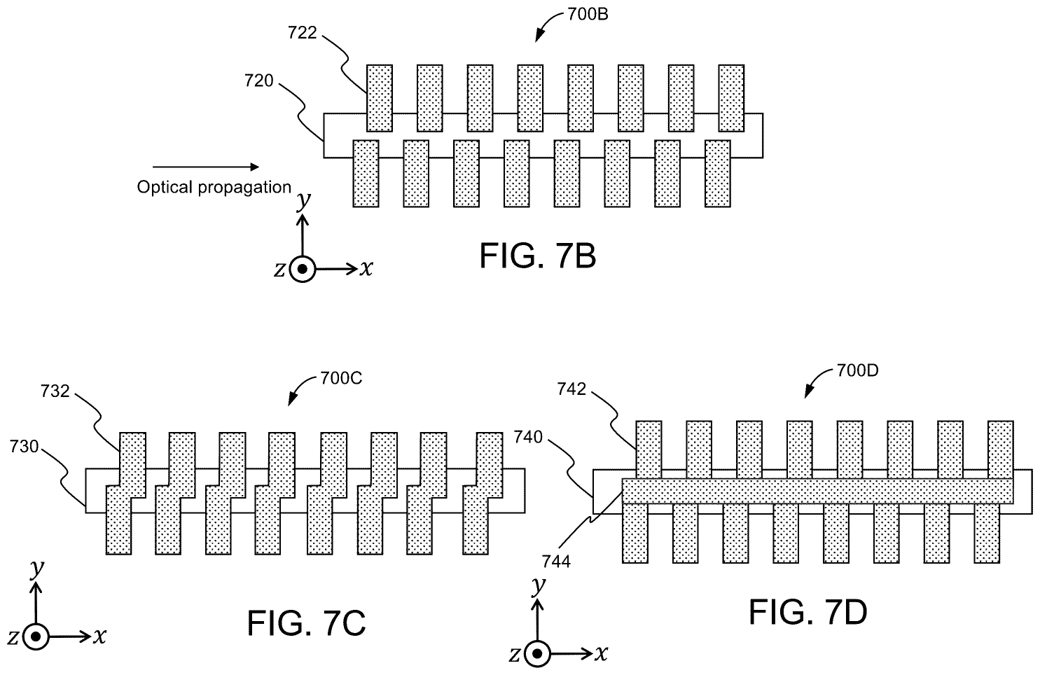

FIG. 7A shows an example first plot 702A, an example second plot 702B, and an example third plot 702C of light intensity as a function of angle in air for a corresponding first grating antenna 704A, a second grating antenna 704B, and a third grating antenna 704C, respectively. Each of the first grating antenna 704A, the second grating antenna 704B, and the third grating antenna 704C have a respective grating element arrangement comprising grating elements 706A, grating elements 706B, and grating elements 706C optically coupled to, i.e., in contact with, a waveguide 708A, a waveguide 708B, and a waveguide 708C, respectively. Optical waves propagate along the x-axis through each of the waveguide 708A, the waveguide 708B, and the waveguide 708C. In the first grating antenna 704A, grating elements 706A are arranged in a single row and each grating element extends in a direction that is perpendicular to the propagation axis, in this example parallel to the y-axis. In the second grating antenna 704B, grating elements 706B are arranged in two disconnected rows of the same pitch but with different portions of a grating element offset from one another by a first offset 707A. In the third grating antenna 704C, grating elements 706C are arranged in two disconnected rows of the same pitch but with different grating element portions further offset from one another relative to the offset of the second grating antenna 704B by a second offset 707B that, in this example, is larger than the first offset 707A. In such a configuration, an optical wave traveling along the propagation axis through the second grating antenna 704B and the third grating antenna 704C is perturbed by a first portion of a grating element and then perturbed by a second offset portion of the grating element. In other words, each grating element of the plurality of grating comprises a first portion positioned to perturb an optical wave at a first location along a propagation axis of a waveguide and a second portion positioned to perturb a second portion of the wavefront at a second location along the propagation axis different from the first location, where the second portion of the wavefront is at least partially non-overlapping with the first portion of the wavefront. Optical antennas that are capable of this perturbation are also demonstrated in FIG. 7B, 7C, 7D, and 6B. The first plot 702A, corresponding to the first grating antenna 704A, shows a centered emission pattern. The second plot 702B, corresponding to the second grating antenna 704B, shows an angularly offset emission pattern. The third plot 702C, corresponding to the third grating antenna 704C, shows a further angular offset emission pattern relative to the second plot 702B. Thus, by increasing the offset between two rows of grating elements, the emission pattern can be further angularly offset. In some examples, more than two rows of grating elements may be used. In other examples, the grating elements can form two connected rows of the same pitch but offset from one another, as shown in FIG. 7C. In other examples, the grating elements may form one row that is non-orthogonal (i.e., at an angle) relative to the propagation axis of the waveguide along which they reside, as shown in FIG. 6B. By arranging grating elements such that a flat wavefront is perturbed (i.e., phase-shifted) at different locations along the propagation axis, an optical wave within the waveguide can have an angularly offset emission pattern. Furthermore, non-flat wavefronts can also be accounted for in the grating element arrangements to apply desired angular offsets.

In some implementations, the grating elements can comprise a first set of grating elements that comprise adjacent grating elements separated from each other along a propagation axis of a waveguide by a first length, and a second set of grating elements with adjacent grating elements separated from each other along the propagation axis by the first length, where the second set of grating elements is separated from the first set of grating elements along the propagation axis by a gap without any grating elements at least twice as large as the first length.

FIG. 7B shows an example grating antenna 700B comprising a waveguide 720 and grating elements 722 optically coupled to the waveguide 720. Along a direction parallel to the propagation axis of the waveguide 720, in this example along the x-axis, the grating elements 722 are arranged into two disconnected rows of the same pitch but with different grating element portions offset from one another.

FIG. 7C shows an example grating antenna 700C comprising a waveguide 730 and grating elements 732 optically coupled to the waveguide 730. Along a direction parallel to the propagation axis of the waveguide 730, the grating elements 732 are arranged into two connected rows of the same pitch but with different grating element portions offset from one another.

FIG. 7D shows an example grating antenna 700D comprising a waveguide 740 and grating elements 742 optically coupled to the waveguide 740. Along a direction parallel to the propagation axis of the waveguide 740, the grating elements 742 are arranged into two rows of the same pitch, but offset from one another, wherein the two rows are connected by a strip 744 parallel to the propagation axis of the waveguide 740.

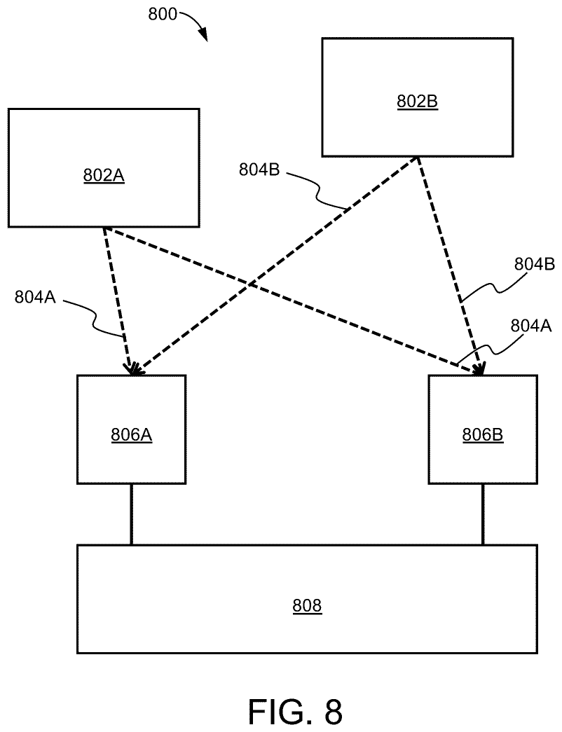

In some implementations, a sidelobe recovery method can be included in a communication system, wherein a transmit aperture is separate from one or more receive apertures. FIG. 8 depicts an example communication system 800. Some communication systems can transmit optical beams over free space and are configured as free space optical communication systems. The communication system 800 comprises a first transmit aperture 802A configured to provide an optical beam comprising a first lobe 804A and a second transmit aperture 802B configured to provide an optical beam comprising a second lobe 804B, i.e., corresponding to far-field angular intensity patterns. In some examples, the first lobe 804A can be the main lobe of an optical beam while the second lobe 804B can be a side lobe of an optical beam. A portion of the first lobe 804A and a portion of the second lobe 804B are collected by a first receive aperture 806A and a second receive aperture 806B. The communication system 800 also comprises circuitry 808 configured to detect optical waves collected by the first receive aperture 806A and the second receive aperture 806B. In some examples, the circuitry 808 can be configured to reconstruct information sent from the first transmit aperture 802A and the second transmit aperture 802B.

Some optical beams can be associated with a power distribution, sometimes referred to as a speckle distribution, wherein optical power is distributed over an area. For instance, an optical beam provided by a LiDAR system interacting with an object can have a speckle distribution on the object that is based on surface properties, i.e., surface roughness or reflectivity, of the object. In some examples, delineating between optical signals from a first lobe and a second lobe can comprise sampling from a speckle distribution associated with an optical beam. In some examples, sampling from a speckle distribution can comprise using one or more receive apertures to detect events associated with an optical beam interacting with an object.

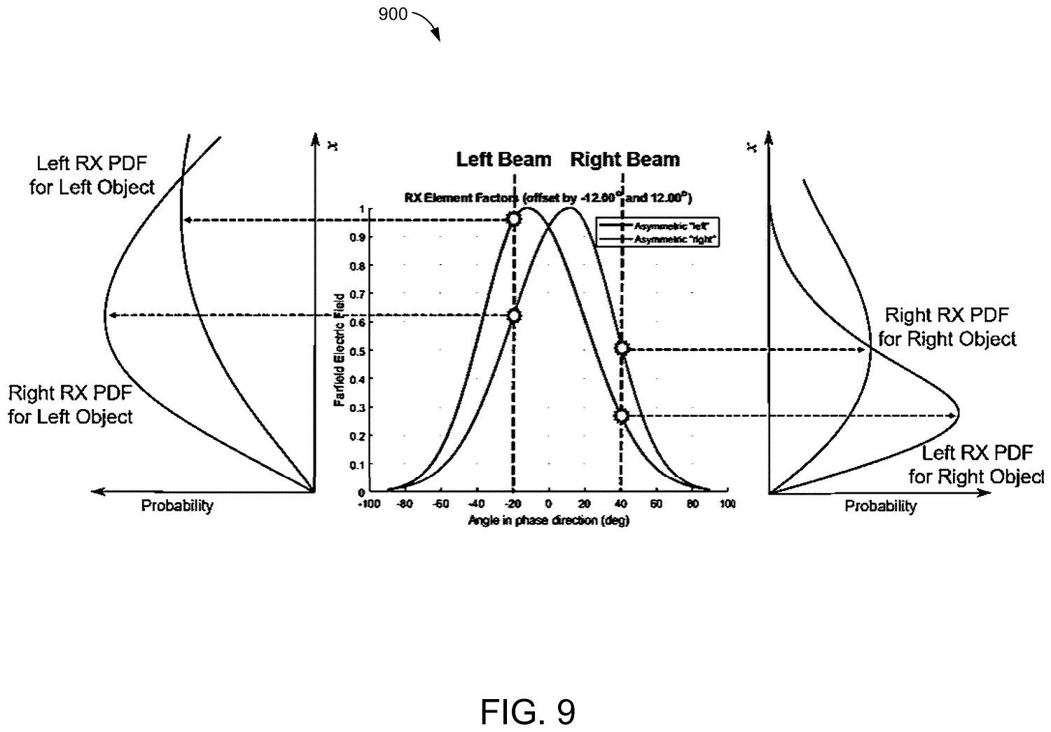

FIG. 9 depicts plots associated with sampling from speckle distributions. The plot 900 depicts numerical simulations of far-field electric fields for a transmit aperture configured to transmit an optical beam pointing to the left, i.e., a left beam, and an optical beam pointing to the right, i.e., a right beam. Receive apertures, such as the receive apertures depicted in FIG. 1C, can be used to sample from a speckle distribution associated with each of the left beam or the right beam interacting with an object. In some implementations, a subset of a plurality of receive apertures can be configured according to element factors. In some examples, a probability that a subset of receive apertures receives optical signals from an optical beam can be associated with a probability density function that is associated with the element factors. In some examples, a first subset of a plurality of receive apertures can be configured to sample from a first probability density function while a second subset of a plurality of receive apertures can be configured to sample from a second probability density function. FIG. 9 depicts a plot 902 of numerical simulations associated with using receive apertures with different element factors to sample from a probability density function associated with the left beam. The plot 902 shows “left receive apertures,” i.e., the receive apertures 144A-144D, and “right receive apertures,” i.e., the receive apertures 144E-144H, sampling from the left beam interacting with an object. In other words, measuring the speckle distribution of the left beam interacting with an object using the left receive apertures samples from the first probability density function. Measuring the speckle distribution of the left beam interacting with an object using right receive apertures samples from a second probability density function. The first probability density function and the second probability density function are different. FIG. 9 also depicts a plot 904 of numerical simulations associated with using receive apertures with different element factors to sample from a probability density function associated with the right beam. The plot 904 shows “left receive apertures,” i.e., the receive apertures 144A-144D, and “right receive apertures,” i.e., the receive apertures 144E-144H, sampling from the right beam interacting with an object. As shown by the plot 902 and the plot 904, the left beam interacting with an object can be delineated from the right beam interacting with an object, as shown by the different probability density functions.

In some examples, decreasing a probability of an ambiguity error can comprise comparing a first speckle distribution to a second speckle distribution, where the first speckle distribution is sampled using a first set of receive apertures and the second speckle distribution is sampled using a second set of receive apertures. For instance, in some implementations, a ratio of an electric field received at the first set of receive apertures to an electric field received at the second set of receive apertures can be calculated. In some examples, this ratio can be expressed as a function of characteristics of a system, including a pointing angle of a first lobe and a second lobe, a range of an object, and a relative alignment of a transmitter or receiver apertures.

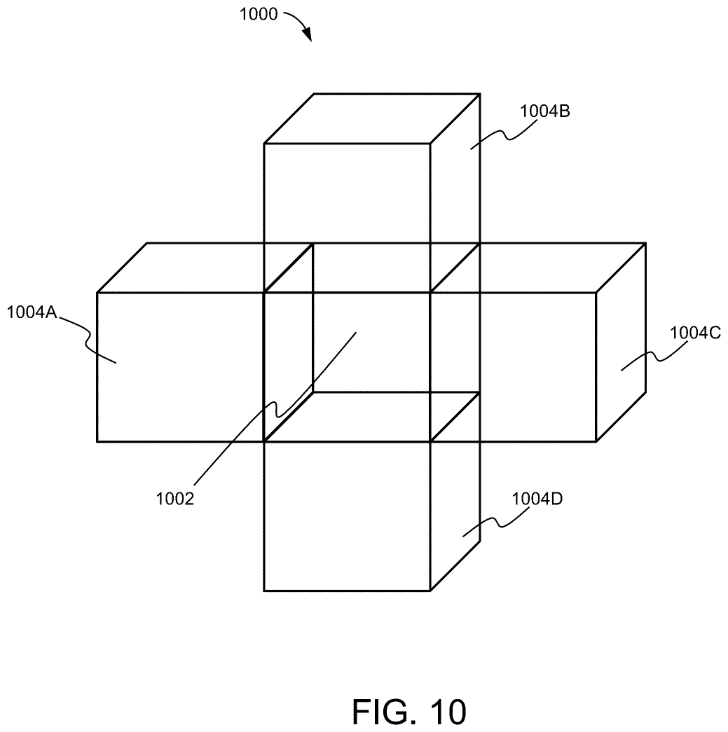

In some implementations, delineating between optical signals associated with a first lobe interacting with an object and a second lobe interacting with an object, i.e., in a LiDAR system, can comprise filtering techniques. As previously described, some systems can perform operations such as a fast Fourier Transform to determine information such as a speed and/or a range of an object in proximity to a LiDAR system. In some implementations, a filtering technique can comprise constructing voxels containing information associated with a fast Fourier Transform. In some examples, these voxels can comprise three-dimensional data, such as a speed of an object, a range of an object, and one of two angles at which an object can be located, i.e., an angular position of a first lobe or an angular position of a second lobe. FIG. 10 depicts an example arrangement 1000 of a voxel 1002 with a plurality of neighboring voxels 1004A-1004D, i.e., a voxel 1004A, a voxel 1004B, a voxel 1004C, and a voxel 1004D. In this example, the arrangement 1000 of voxels is associated with a data collection event by a system at a point in time. A data analysis algorithm can be applied to voxels within a frame of data collection by comparing one voxel to neighboring voxels. For instance, the voxel 1002 can be compared to each voxel of the plurality of neighboring voxels 1004A-1004D. In some examples, by comparing the information in a voxel to neighboring voxels, a probability of an ambiguity error can be decreased. In addition, false alarms associated with a system delineating between a first lobe and a second lobe can be decreased.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
at least one transmit aperture configured to provide an optical beam having a far-field angular intensity pattern comprising a first lobe at a first angular position and a second lobe at a second angular position different from the first angular position; and
a plurality of receive apertures configured to receive optical beams, each receive aperture of the plurality of receive apertures comprising a respective optical phased array (OPA) formed by a plurality of antenna elements, where each antenna element of the plurality of antenna elements comprises:
a waveguide coupled to a phase shifter, and
a plurality of grating elements arranged along the waveguide according to an element factor associated with the respective OPA;
wherein the element factors associated with at least two different OPAs of respective receive apertures of the plurality of receive apertures correspond to different respective far-field angular intensity patterns that at least partially overlap;
wherein the far-field angular intensity pattern of the at least one transmit aperture at least partially overlaps with the far-field angular intensity patterns of the at least two different OPAs of respective receive apertures of the plurality of receive apertures.

2. The apparatus of claim 1, further comprising a signal processing module configured to process optical signals received from the plurality of receive apertures to resolve a detected event associated with either the first lobe or the second lobe of the far-field angular intensity pattern of the at least one transmit aperture.

3. The apparatus of claim 2, wherein the signal processing module is further configured to resolve a detected event associated with both of the first lobe and the second lobe of the far-field angular intensity pattern of the at least one transmit aperture.

4. The apparatus of claim 1, wherein an element factor associated with an OPA of a first receive aperture corresponds to an asymmetric far-field angular intensity pattern.

5. The apparatus of claim 4, wherein an element factor associated with an OPA of a second receive aperture corresponds to an asymmetric far-field angular intensity pattern that is different from the asymmetric far-field angular intensity pattern of the first receive aperture.

6. The apparatus of claim 4, wherein an element factor associated with an OPA of a second receive aperture corresponds to a symmetric far-field angular intensity pattern.

7. The apparatus of claim 1, wherein the at least one transmit aperture comprises an OPA with a plurality of antenna elements, each antenna element of the plurality of antenna elements comprising a respective plurality of waveguides coupled to respective phase shifters, and a plurality of grating elements arranged along each waveguide of the respective plurality of waveguides according to a respective element factor associated with the OPA of the at least one transmit aperture.

8. The apparatus of claim 7, where the element factor of the OPA of the at least one transmit aperture is different from the element factors associated with the at least two different OPAs of the plurality of receive apertures.

9. The apparatus of claim 7, wherein the element factor of the OPA of the at least one transmit aperture corresponds to a symmetric far-field angular intensity pattern that at least partially overlaps with the far-field angular intensity patterns of the at least two different OPAs of the receive aperture.

10. The apparatus of claim 1, wherein each grating element of the plurality of grating elements of each antenna element of the plurality of antenna elements of an OPA of at least one receive aperture of the plurality of receive apertures comprises a first portion positioned to perturb a first portion of a wavefront of an optical wave at a first location along a propagation axis of a waveguide, and a second portion positioned to perturb a second portion of the wavefront at a second location along the propagation axis different from the first location, where the second portion of the wavefront is at least partially non-overlapping with the first portion of the wavefront.

11. The apparatus of claim 10, wherein that grating element of the plurality of grating elements comprises: the first portion in contact with the waveguide at the first location and extending along a direction substantially perpendicular to the propagation axis, and the second portion in contact with the waveguide at the second location and extending along a direction substantially perpendicular to the propagation axis.

12. The apparatus of claim 10, wherein the first portion and the second portion of a particular grating element are connected to each other.

13. The apparatus of claim 1, wherein each antenna element of a plurality of antenna elements of an OPA of at least one receive aperture of the plurality of receive apertures comprises the plurality of grating elements distributed along the waveguide along a propagation axis of the waveguide, the plurality of grating elements comprising: a first set of grating elements with adjacent grating elements separated from each other along the propagation axis by a first length, and a second set of grating elements with adjacent grating elements separated from each other along the propagation axis by the first length, where the second set of grating elements is separated from the first set of grating elements along the propagation axis by a gap without any grating elements at least twice as large as the first length.

14. The apparatus of claim 1, wherein each element factor associated with an OPA of a receive aperture of the plurality of receive apertures corresponds to a different respective far-field angular intensity pattern, where the far-field angular intensity patterns of any two OPAs of respective receive apertures of the plurality of receive apertures at least partially overlap.

15. The apparatus of claim 1, wherein the first lobe corresponds to a main lobe of the far-field angular intensity pattern of the at least one transmit aperture and the second lobe corresponds to a side lobe of the far-field angular intensity pattern of the at least one transmit aperture.

16. A method comprising:
transmitting, using a transmit aperture, an optical beam having a far-field angular intensity pattern comprising a first lobe at a first angular position and a second lobe at a second angular position different from the first angular position;
receiving, at each receive aperture of at least two receive apertures, respective optical beams, where each receive aperture of the at least two receive apertures comprises a respective optical phased array (OPA) that is configured according to different respective far-field angular intensity patterns;
comparing one or more detected events associated with an optical beam received at a first receive aperture of the at least two receive apertures with one or more detected events associated with an optical beam received at a second receive aperture of the at least two receive apertures; and
determining, based at least in part on a result of the comparing, whether the optical beam received at the first receive aperture corresponds to the first lobe or the second lobe of the optical beam transmitted by the transmit aperture;
wherein the far-field angular intensity patterns of the at least two receive apertures at least partially overlap.

17. The method of claim 16, wherein each OPA of each receive aperture of the at least two receive apertures comprises a respective plurality of waveguides, each waveguide of the respective plurality of waveguides coupled to a respective phase shifter, and a plurality of grating elements arranged along each waveguide of the respective plurality of waveguides according to an element factor associated with that OPA.

18. The method of claim 17, wherein each element factor of a respective OPA of a respective receive aperture of the at least two receive apertures corresponds to the different respective far-field angular intensity pattern of the respective OPA.

19. The method of claim 18, wherein each element factor corresponds to a different respective asymmetric far-field angular intensity pattern.

20. The method of claim 16, wherein the first lobe is a main lobe of the far-field angular intensity pattern of the transmit aperture and the second lobe is a side lobe of the far-field angular intensity pattern of the transmit aperture.

21. The method of claim 16, wherein each of the optical beam received at the first receive aperture and the optical beam received at the second receive aperture comprise respective back-reflected portions of the optical beam transmitted by the transmit aperture associated with at least one of the first lobe or the second lobe.

22. The method of claim 16, further comprising comparing one or more respective detected events associated with a respective optical beam arriving at each receive aperture of the at least two receive apertures with respective detected events associated with a respective optical beam arriving at each other receive aperture of the at least two receive apertures.

23. The method of claim 16, wherein the comparing one or more detected events associated with an optical beam received at a first receive aperture of the at least two receive apertures with one or more detected events associated with an optical beam received at a second receive aperture of the at least two receive apertures further comprises comparing a first probability distribution that is determined based at least in part on the one or more detected events associated with an optical beam received at the first receive aperture of the at least two receive apertures and a second probability distribution that is determined based at least in part on the one or more detected events associated with an optical beam received at the second receive aperture of the at least two receive apertures.

24. The method of claim 16, wherein the comparing one or more detected events associated with an optical beam received at a first receive aperture of the at least two receive apertures with one or more detected events associated with an optical beam received at a second receive aperture of the at least two receive apertures further comprises determining at least one of: a range of an object interacting with the first lobe, a range of an object interacting with the second lobe, a speed of an object interacting with the first lobe, or a speed of an object interacting with the second lobe.

25. A method of configuring a LiDAR system, the method comprising:
configuring at least one transmit aperture to provide an optical beam having a far-field angular intensity pattern comprising a first lobe at a first angular position and a second lobe at a second angular position different from the first angular position; and
arranging a plurality of receive apertures relative to the transmit aperture, each receive aperture of the plurality of receive apertures comprising a respective optical phased array (OPA) formed by a plurality of antenna elements, where each antenna element of the plurality of antenna elements comprises:
a waveguide coupled to a phase shifter, and
a plurality of grating elements arranged along the waveguide according to an element factor associated with the respective OPA;
wherein the element factors associated with at least two different OPAs of respective receive apertures of the plurality of receive apertures correspond to different respective far-field angular intensity patterns that at least partially overlap;
wherein the far-field angular intensity pattern of the at least one transmit aperture at least partially overlaps with the far-field angular intensity patterns of the at least two different OPAs of respective receive apertures of the plurality of receive apertures.
